(19) United States
(12) Patent Application Publication
(10) Pub. No.: US 2007/0051800 A1
(43) Pub. Date: Mar. 8, 2007

(54) Operation guidance display unit, operation guidance display program, operation guidance display method, and checkout system

(75) Inventors: Yuko Muto, Inagi (JP); Makoto Hayamizu, Inagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki (JP); FUJITSU FRONTECH LIMITED, Tokyo (JP)

(21) Appl. No.: 11/313,697

(22) Filed: Dec. 22, 2005

(30) Foreign Application Priority Data
Sep. 7, 2005 (JP) 2005-259648

(51) Int. Cl. G06K 15/00

(52) U.S. Cl. 235/383

(57) ABSTRACT

The present invention has been made to allow a user to easily grasp the operation area and thereby to easily and quickly perform the operation even in the case where the operation area extends across the entire system. An operation guidance display unit displays the entire appearance of a system to be operated as well as displays the operation position, in a specific manner, relative to the entire appearance of the system to thereby provide guidance of the operation position in the entire system and further displays, in an enlarged manner, the operation method related to the operation position displayed in a specific manner to thereby provide guidance of the operation method.

### BACKGROUND OF THE INVENTION

1. Field of the Invention

The present invention relates to an operation guidance display unit that provides guidance of an operation method used in, for example, a self-checkout system, an operation guidance display program, an operation guidance display method, and a checkout system using the above unit, method, and program.

2. Description of the Related Art

In the field of ATMs used by financial organizations such as banks, a technique of displaying operation procedure for guiding customer's operation to a customer through a display unit in order to allow the customer to easily make a transaction is known. In this technique, firstly, transaction items are displayed on the display unit to allow the customer to make a selection from the transaction items through a touch keyboard. Then, all operation items corresponding to the selected transaction item and a predetermined frame are separately displayed. Within the predetermined frame, guide messages and illustrations indicating detailed operation contents of the operation item are displayed. At the same time, an indication mark indicating the operation item is displayed in such a manner as to be drawn from within the frame. The indication mark is changed along with progress of the operation so that the indication mark indicates the operation item to be operated next. Further, the guide message and illustration are also made corresponding to the operation item to be operated next (refer to, for example, Japanese Patent No. 2806419).

The technique disclosed in the above document targets ATMs provided in banks and the like, where only an operation area which is a part of the machine is displayed in the display unit and the user's operating area is limited to only a display unit (touch keyboard) provided near only a part of the entire machine, a cash drawer port, and a card handling port.

Therefore, when operating the machine such as ATM, the user can bring both the operation contents displayed in the display unit of the machine and the area that he or she operates into the same view. This makes it easy for the user to grasp operation contents as well as operation area and operation method corresponding to the operation contents.

However, in the case of a self-checkout system utilized at the time when a customer purchases commodities, he or she needs to take operational actions for a commodity table, a readout unit such as a barcode, a shopping basket rack, a checkout unit, respectively. That is, customer's operating area extends beyond a single view including the display unit indicating the operation contents. If the configuration as in the prior art, in which only the operation area is displayed on the display unit, is applied to the self-checkout system, it becomes difficult for the customer to grasp the operation position, leading to difficulty in performing the operation itself. This may cause delay of checkout operation to not only impede speedier commercial transaction but also to adversely affect product sales.

### SUMMARY OF THE INVENTION

The present invention has been made to solve the problem of the prior art, and an object thereof is to provide an operation guidance display unit, an operation guidance display program, an operation guidance display method, and a checkout system that allow a user to easily grasp the operation area and thereby to easily and quickly perform the operation even in the case where the operation area extends across the entire system.

To solve the above problem, according to a first aspect of the present invention, there is provided an operation guidance display unit that provides guidance of operation method, comprising: an operation position display section that displays the entire appearance of a system to be operated and displays, in a specific manner, the operation position relative to the entire appearance of the system to thereby provide guidance of the operation position in the entire system; and an operation method display section that displays, in an enlarged manner, the operation method related to the operation position displayed in a specific manner by the operation position display section to thereby provide guidance of the operation method.

In the operation guidance display unit according to the present invention, based on the determination result of an operation completion determination section that determines the completion of the operation related to the operation position specified by the operation position display section, the operation position display section displays, in a specific manner, the operation position corresponding to the operation to be performed next to the completed operation and displays the operation method related to the operation position in an enlarged manner.

The operation guidance display unit according to the present invention comprises a second specification section that is provided at a position in the system to be operated, the position corresponding to the operation position displayed in a specific manner by the operation position display section, and represents that the position is the operation position that has been displayed in a specific manner.

In the operation guidance display unit according to the present invention, there is commonality between the method of specifying the operation position displayed by the operation position display section and the representation method in the second specification section.

The commonality lies in the color displayed in the second specification section and operation position display section or operation method display section. Further, based on the determination result of an operation determination section that determines that the operation corresponding to that displayed by the operation method display section has not been conducted, a notification indicating that the operation has not been conducted is made.

According to a second aspect of the present invention, there is provided a checkout system for checkout of commodities, comprising: a first commodity placement unit on which commodities before checkout are placed; a commodity data readout unit that reads out commodity data related to the commodities placed on the first commodity placement unit; a second commodity placement unit on which the commodities whose data have been read out by the commodity data readout unit are placed; a checkout unit that performs checkout for the price of commodities that have been readout by the commodity data readout unit; and an operation guidance display unit that provides guidance of the operation method of the first commodity placement unit, second commodity placement unit, commodity data readout unit, and checkout unit, the operation guidance display unit comprising: an operation position display section that displays the entire appearance of the checkout system and displays, in a specific manner, the operation position relative to the entire appearance of the system to thereby provide guidance of the operation position in the entire system; and an operation method display section that displays, in an enlarged manner, the operation method related to the operation position displayed in a specific manner by the operation position display section to thereby provide guidance of the operation method.

According to a third aspect of the present invention, there is provided an operation guidance display program allowing a computer to execute display of operation guidance that provides an operation method, the program allowing the computer to execute: an operation position display step that displays the entire appearance of a system to be operated and displays, in a specific manner, the operation position relative to the entire appearance of the system to thereby provide guidance of the operation position in the entire system; and an operation method display step that displays, in an enlarged manner, the operation method related to the operation position displayed in a specific manner by the operation position display step to thereby provide guidance of the operation method.

The operation guidance display program according to the present invention comprises an operation completion determination step that determines the completion of the operation related to the operation position specified by the operation position display step, wherein based on the determination result of the operation completion determination step, the operation position display step displays, in a specific manner, the operation position corresponding to the operation to be performed next to the completed operation and displays the operation method related to the operation position in an enlarged manner.

The operation guidance display program according to the present invention comprises a display step that displays a second specification section in association with the operation position display step. The second specification section is provided at a position in the system to be operated, the position corresponding to the operation position specified by the operation position display step, and represents that the position is the operation position that has been displayed in a specific manner.

The operation guidance display program according to the present invention comprises an operation determination step that determines that the operation corresponding to that displayed by the operation method display step has not been conducted; and a notification step that issues a notification indicating that the operation has not been conducted in the case where the operation determination step determines that the operation has not been conducted.

According to a fourth aspect of the present invention, there is provided an operation guidance display method that provides guidance of an operation method, comprising: an operation position display step that displays the entire appearance of a system to be operated and displays, in a specific manner, the operation position relative to the entire appearance of the system to thereby provide guidance of the operation position in the entire system; and an operation method display step that displays, in an enlarged manner, the operation method related to the operation position displayed in a specific manner by the operation position display step to thereby provide guidance of the operation method.

As described above in detail, according to the present invention, an operation guidance display unit, an operation guidance display program, an operation guidance display method, and a checkout system that allow a user to easily grasp the operation area and thereby to easily and quickly perform the operation even in the case where the operation area extends across the entire system.

### BRIEF DESCRIPTION OF THE DRAWINGS

FIG. 1 is a perspective view showing an outer appearance of a self-checkout system in the embodiment of the present invention;

FIG. 2 is a block diagram showing the embodiment of the present invention;

FIG. 3 is a (first) flowchart showing the operation in the embodiment of the present invention;

FIG. 4 is a (second) flowchart showing the operation in the embodiment of the present invention;

FIG. 5 is a (first) view showing the screen displayed on an operation guidance display section according to the embodiment of the present invention;

FIG. 6 is a (second) view showing the screen displayed on an operation guidance display section according to the embodiment of the present invention;

FIG. 7 is a (third) view showing the screen displayed on an operation guidance display section according to the embodiment of the present invention; and

FIG. 8 is an enlarged view showing the details of a part of the displayed screen.

### DETAILED DESCRIPTION OF THE PREFERRED EMBODIMENTS

An embodiment of the present invention will be described with reference to the accompanying drawings, taking a self-checkout system used at the time of purchase of commodities as an example.

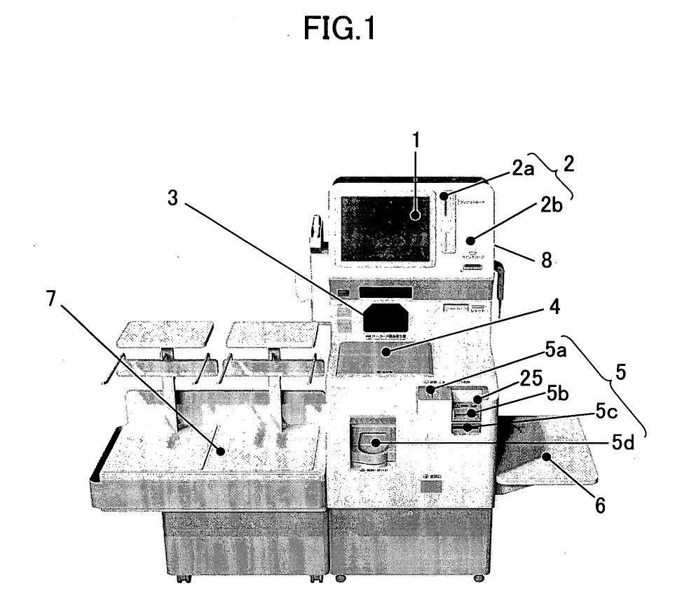

FIG. 1 is a perspective view showing an outer appearance of a self-checkout system in the embodiment of the present invention.

This self-checkout system includes a guidance display section 1 that provides guidance of how to operate the system to the user through an image, a card handling section 2 that handles cards, a scanner 3 that reads out barcode attached to commodity, a checkout section 5 that receives cash payments and makes change, a shopping basket tray 6 on which a shopping basket containing commodities is placed, and a commodity table 7 on which commodities whose barcodes have been read out are placed. The commodity table 7 also serves as a weight detection section that can detect the weight of commodities. Alternatively, a weight detection section 4 may independently be provided.

The guidance display section 1 constitutes a guidance display unit of the present invention and includes a touch panel display. The card handling section (card handling unit) 2 is provided on the side of the touch panel display and includes a credit card reader 2a and point card reader/writer 2b. Flicker lamps that indicate the positions of the credit card reader 2a and point card reader/writer 2b are provided near them, respectively.

The scanner (commodity data readout unit) 3 is provided below the guidance display section 1, and the weight detection section 4 is provided below the front of the scanner 3. The weight detection section 4 has a tabular shape and can be used for detection of the weight of commodities. The checkout section (checkout unit) 5 is provided on the lower side of the weight detection section 4 and includes, on the front side thereof, a coin insertion slot 5a, a bill insertion slot 5b, a change slot for bills 5c, and a change slot for coins 5d. Flicker lamps that indicate the positions of the coin insertion slot 5a and bill insertion slot 5b are provided near them, respectively.

The shopping basket tray (first commodity placement unit) 6 is provided below and on the right side of the guidance display section 1 as viewed from the front at a predetermined height position. This height position is set so that the user can easily place a shopping basket on the shopping basket tray. The commodity table (second commodity placement unit) 7 is provided, at the same height position as that of the shopping basket tray 6, below and on the left side of the guidance display section 1 and scanner 3, that is, provided at the portion on the opposite side of the shopping basket tray 6 with respect to the guidance display section 1. A weight detection section is provided also for the commodity table 7 so that the user can use it according to need.

In the above configuration, the respective units serving as the guidance display section 1, card handling section 2, scanner 3, commodity weight detection section 4, and checkout section 5 are incorporated in a single casing 8, on both sides of which the shopping basket tray 6 and commodity table 7 are provided.

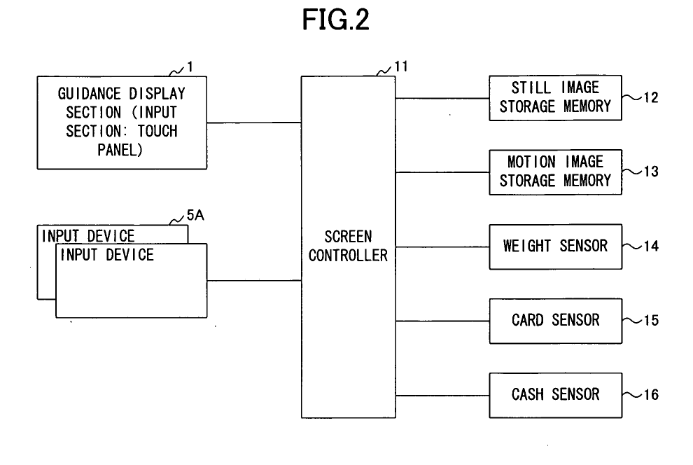

FIG. 2 is a block diagram showing a functional configuration of the checkout system in the present embodiment. Connected to a screen controller 11 that controls the guidance display section 1 are an input device 5A that serves as the checkout section 5 and the like, a still image storage memory 12 that stores still images, a motion image storage memory 13 that stores motion images, a weight sensor 14 serving as the weight detection section 4 and the like, a card sensor 15 that detects presence/absence of card, and a cash sensor 16 that detects presence/absence of cash. The operation guidance display unit according to the present invention has the configuration shown in FIG. 2 in the present embodiment.

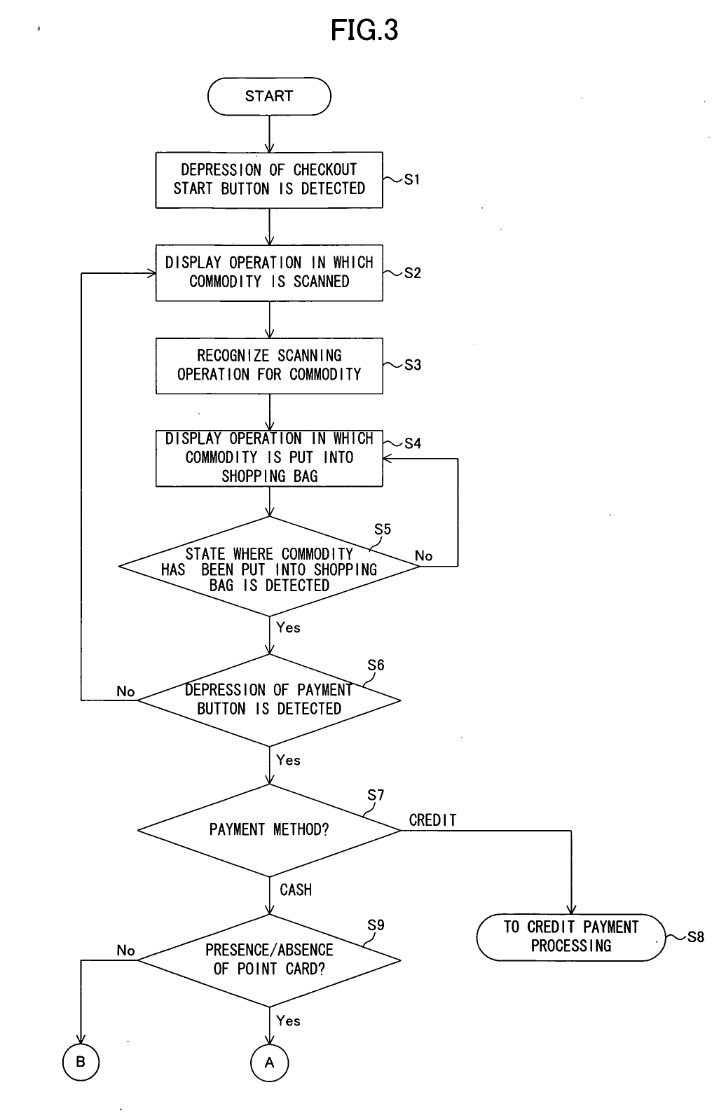

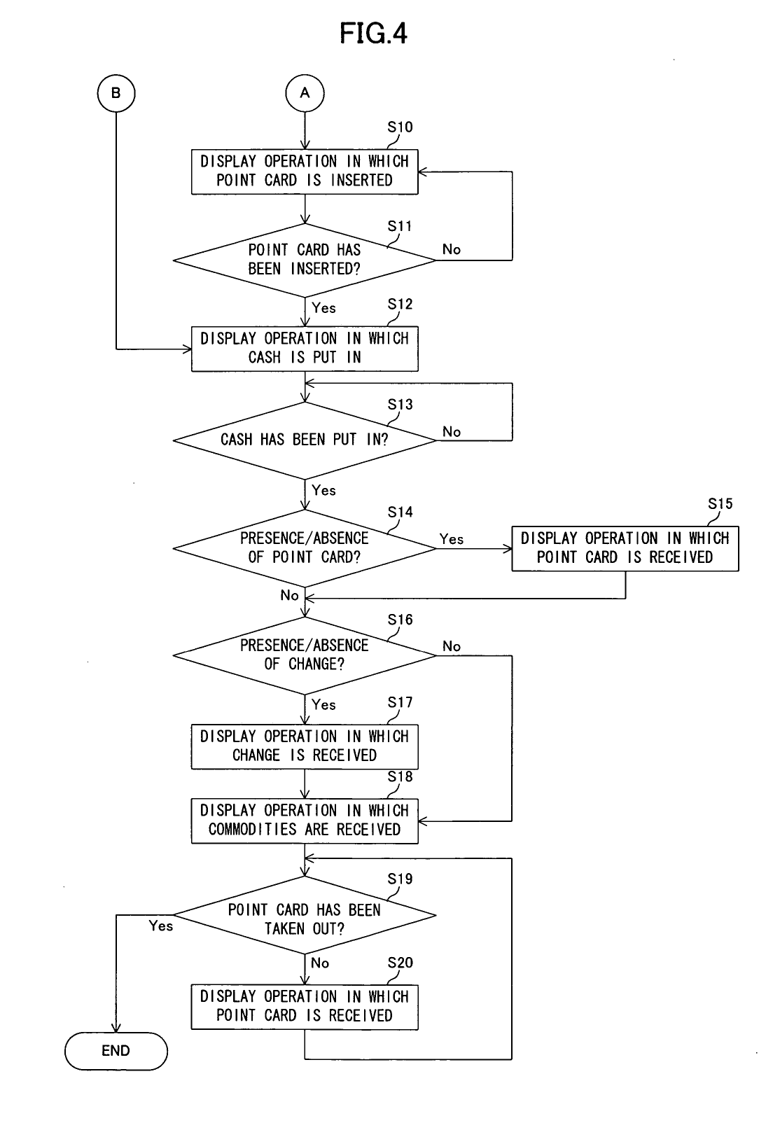

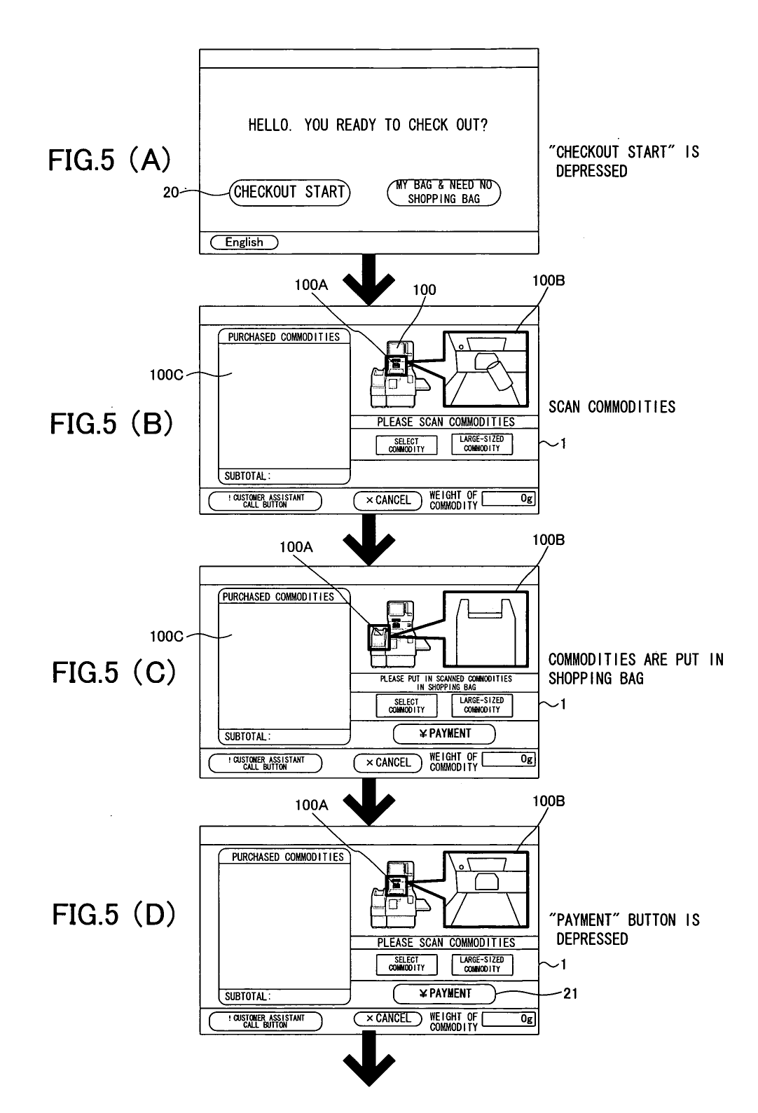

The operation in the present embodiment will be described with reference to the flowcharts shown in FIGS. 3 and 4, and screen examples shown in FIGS. 5 to 8.

Firstly, a customer places a shopping basket containing commodities on the shopping basket tray 6 and depresses a checkout start button 20 shown in FIG. 5(A). When the depression of the checkout start button 20 is detected (step S1), the screen of the guidance display section 1 is shifted from the state shown in FIG. 5(A) to the state shown in FIG. 5(B). In the state of FIG. 5(B), operation in which the scanner 3 is used to scan the commodity is displayed (step S2).

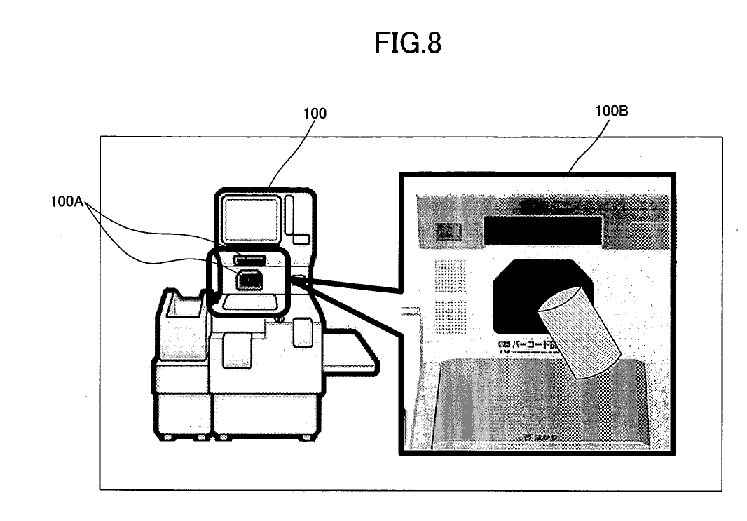

In this state, as shown in detail in FIG. 8, the outer appearance of the entire system 100 is displayed as a still image and, at the same time, the operation position (scanner, in this case) 100A is highlighted in the outer appearance 100. In this highlight display, a different color relative to the base (for example, red is used as an emphasis color relative to the white base) is used to surround only the operation position. This allows the customer to easily understand the operation position relative to the entire system.

An operation position display section of the present invention is constituted by the display of the operation position relative to the outer appearance of the entire system. An operation method related to the operation position that has been highlighted by the operation position display section is displayed, in an enlarged manner, in the form of a balloon (100B) by the side of the operation position display section. This operation method is displayed as a motion image. Therefore, the user can easily and quickly grasp the operation position and detailed operation method at a time.

A purchased commodity item display section 100C is provided next to the display sections of the operation position and operation method in the guidance display section 1. The user can confirm the result of commodity purchase operation on the purchased commodity item display section 100C.

When the commodity scanning operation is recognized (step S3), operation in which the scanned commodity is put into a shopping bag is displayed (step S4) as shown in FIG. 5(C). At this time, the commodity table 7 is highlighted as the operation position 100A. As described above, when the user finishes one operation (scanning operation, etc.), the highlighted position is shifted to the operation position corresponding to the operation to be performed next. This transition is made in the outer appearance of the entire system 100, so that the user can easily grasp the operation position. Further, this operation is announced by voice.

When it is determined that the commodity is put in the shopping bag (step S5: for example, this is determined using the detection function of the weight detection section of the commodity table 7), the screen is shifted to the state shown in FIG. 5(D). The above operation is repeated until the user depresses a payment button 21 (YES in step S6) displayed in the guidance display section 1. Although an error indication may be displayed when it is determined that commodity is not put in the shopping bag, description thereof is omitted here.

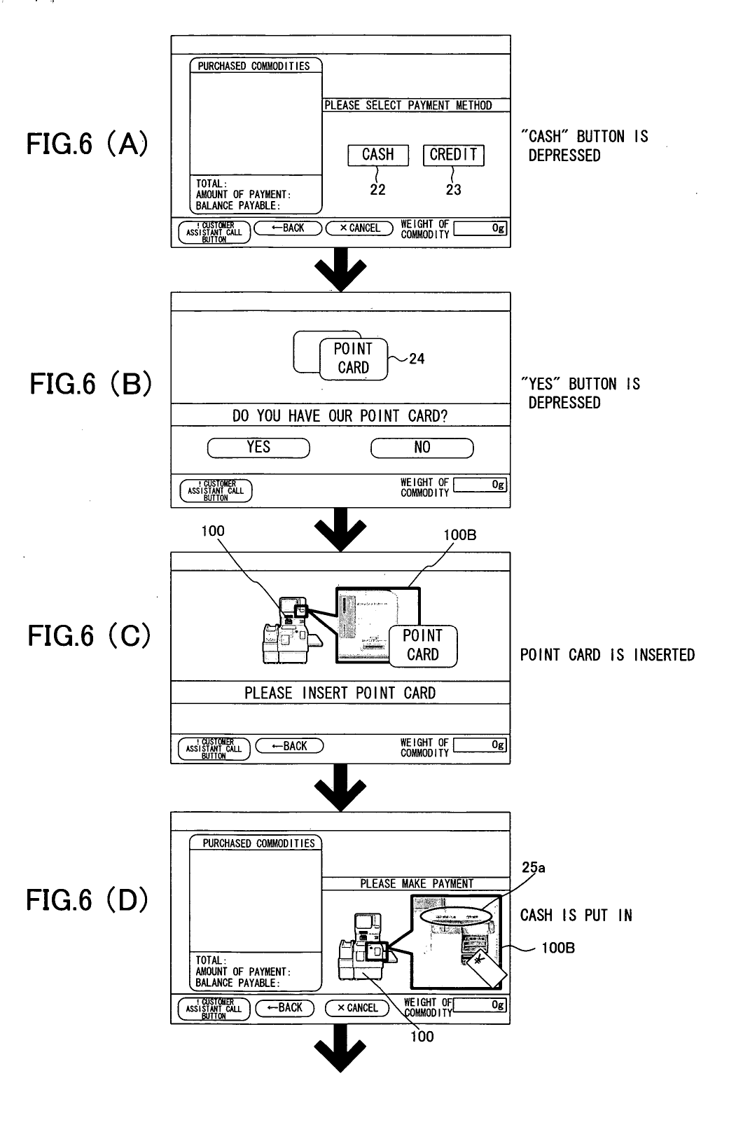

When the depression of the payment button 21 in FIG. 5(D) is detected (YES in step S6), inquiry about the method of payment (cash payment or card payment) is made (step S7). At this time, the content as shown in FIG. 6(A) is displayed on the guidance display section 1, where “CASH” button 22 and “CREDIT” button 23 are displayed.

A description will be made of the case where “CASH” button 22 is selected in FIG. 6(A) (step S7: CASH). Although the payment processing method includes credit payment processing (step S8) to be performed in the case where “CREDIT” button 23 is selected (step S7: CREDIT), description thereof is omitted here.

When the cash payment is selected (step 7: CASH), the screen of the guidance display section is shifted to the state shown FIG. 6(B), where inquiry about presence/absence of a point card 24 is made (step S9). When the user has the point card 24 (YES in step S9), he or she depresses “YES” button and point card insertion operation is displayed as shown in FIG. 6(C) (step S10). When the point card is inserted according to the operation guidance (YES in step S11), operation of cash payment method is displayed as shown in FIG. 6(D) (step S12).

The content of the operation of cash payment method causes the direction of the user's eyes to be largely changed from the position where the user has operated. Therefore, a lump 25 (FIG. 1) provided in the system main body is blinked. In this case, as shown in the balloon 100B of FIG. 6(D), a lamp 25a of the cash slot displayed in the screen representing the operation method is blinked in the same colors. The representation of the commonality in the lamp color or blink frequency allows the user to grasp the operation position more easily. The lamps 25 and 25a constitute a second specification section.

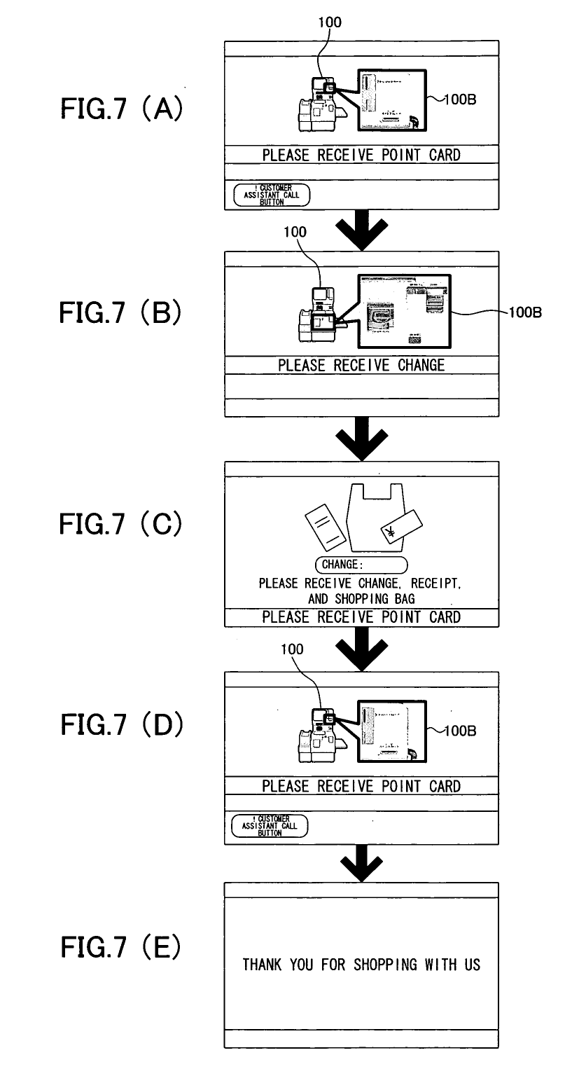

The user then inserts cash according to the screen displaying the operation of cash payment method (YES in step S13). When the user has the point card (YES in step S14), operation related to reception of the point card is displayed as shown in FIG. 7(A) (step S15). Next, presence/absence of the change is determined (step S16). When it is determined that there is the change (YES in step S16), operation related to reception of the change is displayed as shown in FIG. 7(B) (step S17). A sensor may be provided at the change slot. In this case, it is possible to prolong the display time of FIG. 7(B) based on the sensor output. Further, in the case where the change is left in the change slot for a long time, it is possible to issue notification by a voice alarm so as to prompt the user to receive the change (notification step).

When the reception of the change is detected by the sensor or the like, operation related to the reception of the commodities is displayed as shown in FIG. 7(C) (step S18).

When the user does not have the point card in step S14 (NO in step S14), operation is directly shifted to step S16. Further, when there is no change in step S16, operation is directly shifted to step S18.

It is determined that the point card has been taken out (step S19) after the display of the commodity reception operation (step S18). When the point card has not been taken out (No in step S19), the operation related to the point card reception operation is displayed as shown in FIG. 7(D) (step S20).

A card sensor 15 that detects presence/absence of the point card may be used to allow the display of the operation related to the point card reception operation to be continued until the point card has been taken out. Further, in the case where the display of the operation related to the point card reception operation continues for a predetermined time, it is possible to issue notification by a voice. When the point card has been already take out (YES in step S19), operation is ended and the screen is shifted to FIG. 7(E).

Although the present invention has been described taking the self-checkout system used at the time of purchase of commodities as an example, the present invention is not limited to the self-checkout system, but is applied to various types of systems in which user's operation area is so wide that it goes beyond a single view including the display screen of the operation guidance display unit and can significantly increase the operability of the system.

When the respective steps shown in FIGS. 3 and 4 of the embodiment of the present invention described above is stored in a computer-readable storage medium as an operation guidance display program, it is possible to allow a computer to execute operation guidance in, for example, a self-checkout system. The computer-readable storage medium mentioned here includes: a portable storage medium such as a CD-ROM, a flexible disk, a DVD disk, a magneto-optical disk, or an IC card; a database that holds computer program; another computer and database thereof; and a transmission medium on a network line.

What is claimed is:

1. An operation guidance display unit that provides guidance of operation method, comprising:
an operation position display section that displays the entire appearance of a system to be operated and displays, in a specific manner, the operation position relative to the entire appearance of the system to thereby provide guidance of the operation position in the entire system; and
an operation method display section that displays, in an enlarged manner, the operation method related to the operation position displayed in a specific manner by the operation position display section to thereby provide guidance of the operation method.

2. The operation guidance display unit according to claim 1, wherein
based on the determination result of an operation completion determination section that determines the completion of the operation related to the operation position specified by the operation position display section, the operation position display section displays, in an enlarged manner, the operation position corresponding to the operation to be performed next to the completed operation and displays the operation method related to the operation position in a specific manner.

3. The operation guidance display unit according to claim 1, comprising a second specification section that is provided at a position in the system to be operated, the position corresponding to the operation position displayed in a specific manner by the operation position display section, and represents that the position is the operation position that has been displayed in a specific manner.

4. The operation guidance display unit according to claim 3, wherein
there is commonality between the method of specifying the operation position displayed by the operation position display section and the representation method in the second specification section.

5. The operation guidance display unit according to claim 4, wherein
the commonality lies in the color displayed in the second specification section and operation position display section or operation method display section.

6. The operation guidance display unit according to claim 1, wherein
based on the determination result of an operation determination section that determines that the operation corresponding to that displayed by the operation method display section has not been conducted, a notification indicating that the operation has not been conducted is made.

7. A checkout system for checkout of commodities, comprising:
a first commodity placement unit on which commodities before checkout are placed;
a commodity data readout unit that reads out commodity data related to the commodities placed on the first commodity placement unit;
a second commodity placement unit on which the commodities whose data have been read out by the commodity data readout unit are placed;
a checkout unit that performs checkout for the price of commodities that have been read out by the commodity data readout unit; and
an operation guidance display unit that provides guidance of the operation method of the first commodity placement unit, second commodity placement unit, commodity data readout unit, and checkout unit,
the operation guidance display unit comprising: an operation position display section that displays the entire appearance of the checkout system and displays, in a specific manner, the operation position relative to the entire appearance of the system to thereby provide guidance of the operation position in the entire system; and an operation method display section that displays, in an enlarged manner, the operation method related to the operation position displayed in a specific manner by the operation position display section to thereby provide guidance of the operation method.

8. The checkout system according to claim 7, comprising an operation completion determination section that determines the completion of the operation related to the operation position specified by the operation position display section, wherein
based on the determination result of the operation completion determination section, the operation position display section displays, in a specific manner, the operation position corresponding to the operation to be performed next to the completed operation and displays the operation method related to the operation position in an enlarged manner.

9. The checkout system according to claim 7, comprising a second specification section that is provided at a position in the system to be operated, the position corresponding to the operation position displayed in a specific manner by the operation position display section, and represents that the position is the operation position that has been displayed in a specific manner.

10. The checkout system according to claim 9, wherein
there is commonality between the method of specifying the operation position displayed by the operation position display section and the representation method in the second specification section.

11. The checkout system according to claim 10, wherein
the commonality lies in the color displayed in the second specification section and operation position display section or operation method display section.

12. The checkout system according to claim 7, comprising:
an operation determination section that determines that the operation corresponding to that displayed by the operation method display section has not been conducted; and
a notification section that issues a notification indicating that the operation has not been conducted in the case where the operation determination section determines that the operation has not been conducted.

13. An operation guidance display program allowing a computer to execute display of operation guidance that provides an operation method,
the program allowing the computer to execute:
an operation position display step that displays the entire appearance of a system to be operated and displays, in a specific manner, the operation position relative to the entire appearance of the system to thereby provide guidance of the operation position in the entire system; and
an operation method display step that displays, in an enlarged manner, the operation method related to the operation position displayed in a specific manner by, the operation position display step to thereby provide guidance of the operation method.

14. The operation guidance display program according to claim 13, comprising an operation completion determination step that determines the completion of the operation related to the operation position specified by the operation position display step, wherein
based on the determination result of the operation completion determination step, the operation position display step displays, in a specific manner, the operation position corresponding to the operation to be performed next to the completed operation and displays the operation method related to the operation position in an enlarged manner.

15. The operation guidance display program according to claim 13, comprising a display step that displays a second specification section in association with the operation position display step, the second specification section being provided at a position in the system to be operated, the position corresponding to the operation position specified by the operation position display step, and representing that the position is the operation position that has been displayed in a specific manner.

16. The operation guidance display program according to claim 13, comprising:
an operation determination step that determines that the operation corresponding to that displayed by the operation method display step has not been conducted; and
a notification step that issues a notification indicating that the operation has not been conducted in the case where the operation determination step determines that the operation has not been conducted.

17. An operation guidance display method that provides guidance of an operation method, comprising:
an operation position display step that displays the entire appearance of a system to be operated and displays, in a specific manner, the operation position relative to the entire appearance of the system to thereby provide guidance of the operation position in the entire system; and
an operation method display step that displays, in an enlarged manner, the operation method related to the operation position displayed in a specific manner by the operation position display step to thereby provide guidance of the operation method.

18. The operation guidance display method according to claim 17, comprising:
an operation completion determination step that determines the completion of the operation related to the operation position specified by the operation position display step, wherein
based on the determination result of the operation completion determination step, the operation position display step displays, in a specific manner, the operation position corresponding to the operation to be performed next to the completed operation and displays the operation method related to the operation position in an enlarged manner.

19. The operation guidance display method according to claim 17, comprising a display step that displays a second specification section in association with the operation position display step, the second specification section being provided at a position in the system to be operated, the position corresponding to the operation position specified by the operation position display step, and
representing that the position is the operation position that has been displayed in a specific manner.

20. The operation guidance display method according to claim 17, comprising:
an operation determination step that determines that the operation corresponding to that displayed by the operation method display step has not been conducted; and
a notification step that issues a notification indicating that the operation has not been conducted in the case where the operation determination step determines that the operation has not been conducted.
